(19) United States
(12) Patent Application Publication
(10) Pub. No.: US 2021/0336924 A1
(43) Pub. Date: Oct. 28, 2021

(54) DEVICE MANAGEMENT APPARATUS, DEVICE MANAGEMENT SYSTEM, AND DEVICE MANAGEMENT METHOD

(71) Applicant: Ryuta Katoh, TOKYO (JP)

(72) Inventor: Ryuta Katoh, TOKYO (JP)

(73) Assignee: Ricoh Company, Ltd., Tokyo (JP)

(21) Appl. No.: 17/226,336

(22) Filed: Apr. 9, 2021

(30) Foreign Application Priority Data
Apr. 23, 2020 (JP) 2020-076636

(51) Int. Cl. H04L 29/12; H04L 12/24

(52) U.S. Cl. CPC H04L 61/2517; H04L 41/04; H04L 61/1541

(57) ABSTRACT

A device management apparatus, a device management system, and a device management method. The device management apparatus transmits a transmission request for acquiring device information to a first port number of each of a plurality of devices connected through a network, and transmit the transmission request to a second port number of at least one device of the plurality of devices that does not respond to the transmission request transmitted to the first port number.

### CROSS-REFERENCE TO RELATED APPLICATIONS

This patent application is based on and claims priority pursuant to 35 U.S.C. § 119(a) to Japanese Patent Application No. 2020-076636, filed on Apr. 23, 2020 in the Japan Patent Office, the entire disclosure of which is hereby incorporated by reference herein.

### BACKGROUND

### Technical Field

The present disclosure relates to a device management apparatus, a device management system, a device management method, and a non-transitory recording medium.

### Related Art

In order to centrally monitor status of a plurality of devices connected to a network, a system that collects information on each device through a network (hereinafter referred to as a “device management system”) has been used.

On the other hand, a device such as a printer may be connected to a personal computer (PC) connected to the network through a Universal Serial Bus (USB) cable or the like. That is, there may be devices that are not directly connected to the network (hereinafter referred to as “local devices”).

### SUMMARY

Embodiments of the present disclosure describe a device management apparatus, a device management system, and a device management method. The device management apparatus transmits a transmission request for acquiring device information to a first port number of each of a plurality of devices connected through a network, and transmit the transmission request to a second port number of at least one device of the plurality of devices that does not respond to the transmission request transmitted to the first port number.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a configuration of a device management system according to embodiments of the present disclosure;

FIG. 2 is a diagram illustrating an example of a hardware configuration of a device management apparatus according to embodiments of the present disclosure;

FIG. 3 is a diagram illustrating an example of a functional configuration of the device management system according to the embodiments of the present disclosure;

FIG. 4 is a diagram illustrating an example of a setting screen;

FIG. 5 is a sequence diagram illustrating an example of a process executed when port 161 is a priority port; and

FIG. 6 is a sequence diagram illustrating an example of a process executed when port 50161 is a priority port.

The accompanying drawings are intended to depict embodiments of the present invention and should not be interpreted to limit the scope thereof. The accompanying drawings are not to be considered as drawn to scale unless explicitly noted. Also, identical, or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

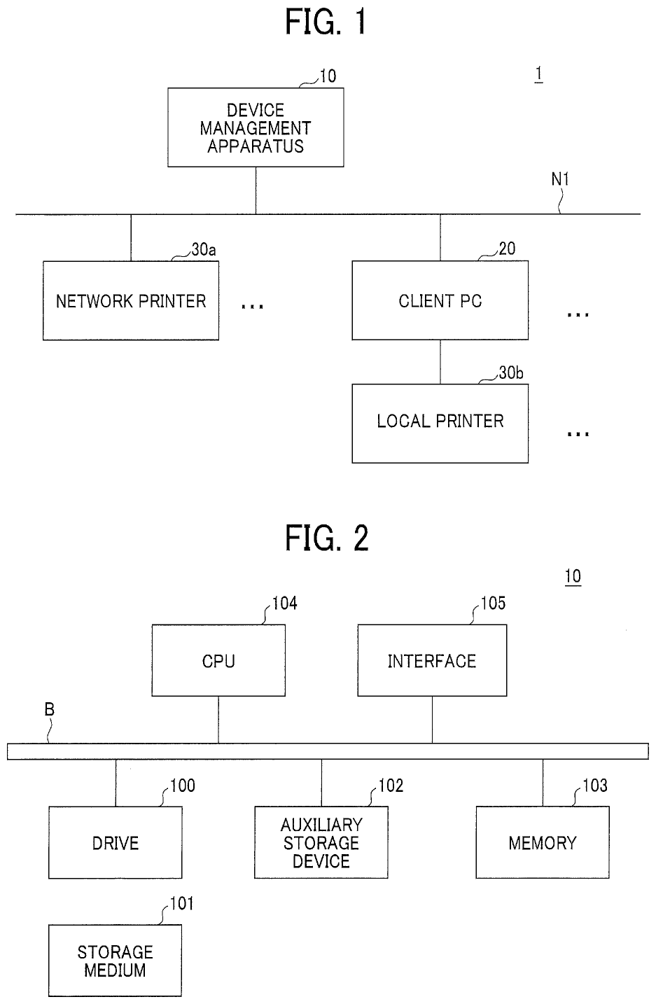

Embodiments of the present disclosure are described below with reference to the drawings. FIG. 1 is a diagram illustrating an example of a configuration of a device management system 1 according to embodiments of the present disclosure. In the device management system 1 illustrated in FIG. 1, a device management apparatus 10 is connected to one or more network printers 30a and one or more client personal computers (PCs) 20 through a network N1 such as a local area network (LAN). A local printer 30b is connected to a part or all of one or more client PCs 20 through a USB cable or the like. In other words, the local printer 30b is connected to the network N1 through the client PC 20. Hereinafter, a local connection through the USB cable or the like is referred to as a “local connection”. Further, the network printer 30a and the local printer 30b are simply referred to as a “printer 30” when the network printer 30a and the local printer 30b are not distinguished. Further, the printer 30 and the client PC 20 are simply referred to as a “device” when the printer 30 and the client PC 20 are not distinguished.

The device management apparatus 10 is one or more computers that acquire (collect) information related to each device (hereinafter referred to as “device information”) from each device and store the acquired device information. The device information is used for monitoring status of each device.

FIG. 1 is a diagram illustrating an example of a hardware configuration of a device management apparatus 10 according to the embodiments of the present disclosure. The device management apparatus 10 as illustrated in FIG. 2 includes a drive 100, an auxiliary storage device 102, a memory 103, a central processing unit (CPU) 104, an interface 105, and the like, which are interconnected through a bus B.

A program that implements processes in the device management apparatus 10 is provided by a storage medium 101 such as a compact disk-read only memory (CD-ROM). When the storage medium 101 storing the program is set in the drive 100, the program is installed in the auxiliary storage device 102 from the storage medium 101 through the drive 100. However, it is not always necessary to install the program from the storage medium 101 and the program may be downloaded from another computer through the network. The auxiliary storage device 102 stores the installed program and also stores necessary files and data.

The memory 103 reads the program from the auxiliary storage device 102 and stores the program when an instruction to activate the program is given. The CPU 104 executes a function related to the device management apparatus 10 according to the program stored in the memory 103. The interface 105 is used as an interface for connecting to a network.

The client PC 20 and the printer 30 may also have the hardware as illustrated in FIG. 2.

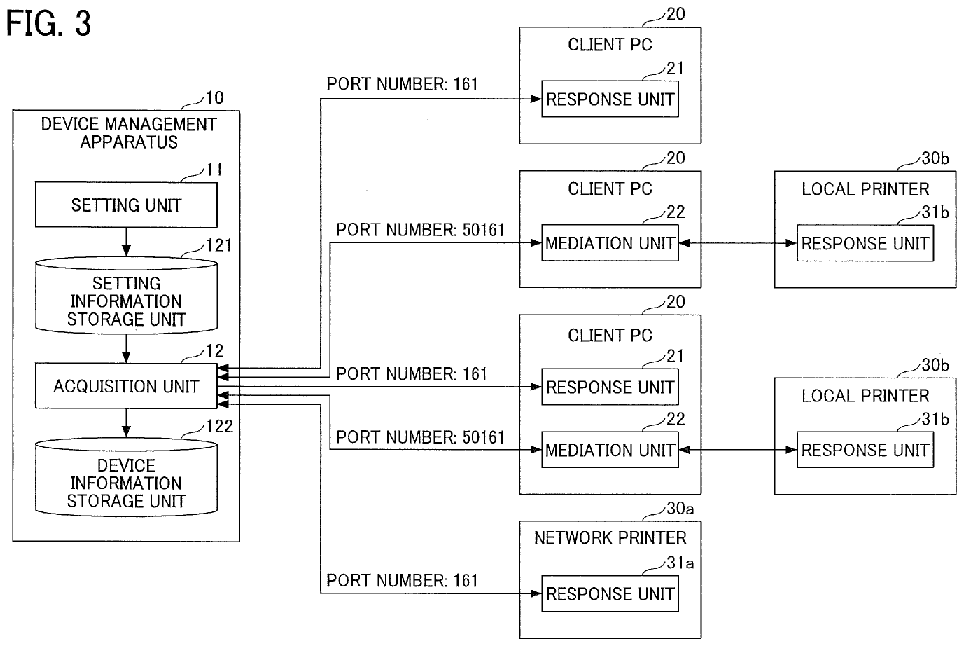

FIG. 3 is a diagram illustrating an example of a functional configuration of the device management system 1 according to the embodiments of the present disclosure. In FIG. 3, each client PC 20 includes one or both of a response unit 21 and a mediation unit 22. Each of these units is implemented by a process in which one or more programs installed in the client PC 20 are executed by the CPU of the client PC 20.

The response unit 21 functions as an agent in Simple Network Management Protocol (SNMP). The response unit 21 opens a port whose port number is 161 (hereinafter referred to as “port 161”) and waits for reception of a device information transmission request addressed to the port (to the port number). In response to receiving the device information transmission request, the response unit 21 transmits a response including device information (that is, Management Information Base (MIB) information) in a format according to SNMP to the device management apparatus 10.

The mediation unit 22 opens a port (hereinafter referred to as “port 50161”) having a port number different from 161 (50161 in the present embodiment) and waits for reception of the device information transmission request addressed to the port (to the port number). In response to receiving the transmission request, the mediation unit 22 transmits the transmission request to the local printer 30b locally connected to the client PC 20 by using the USB data transfer method (control transfer). The mediation unit 22 transmits the device information included in the response returned from the local printer 30b in response to the transmission request to the device management apparatus 10. Therefore, the client PC 20 to which the local printer 30b is not connected does not have to include the mediation unit 22.

The network printer 30a includes a response unit 31a. The response unit 31a functions as an agent in SNMP in the same manner as the response unit 21. That is, the response unit 31a opens port 161 and waits for the reception of the device information transmission request addressed to the port (addressed to the port number). In response to receiving the transmission request, the response unit 31a transmits a response including the device information (that is, MIB information) in a format according to SNMP to the device management apparatus 10.

The local printer 30b includes a response unit 31b. The response unit 31b functions as an agent in SNMP in the same manner as the response unit 21 and the response unit 31a. However, the response unit 31b is different from the response unit 21 and the response unit 31a in that the response unit 31b receives a transmission request for device information through a data transfer method of the USB. In response to receiving the transmission request, the response unit 31b transmits a response containing the device information (MIB information) in the form according to SNMP to the client PC 20 to which the local printer 30b is locally connected (client PC 20 that mediates (relays) between the local printer 30b and the network N1).

The device management apparatus 10 includes a setting unit 11 and an acquisition unit 12. Each of these units is implemented by a process executed by the CPU 104 according to one or more programs installed in the device management apparatus 10. The device management apparatus 10 also includes a setting information storage unit 121 and a device information storage unit 122. Each of these storage units is implemented by using, for example, the auxiliary storage device 102 or a storage device that is connected to the device management apparatus 10 through a network.

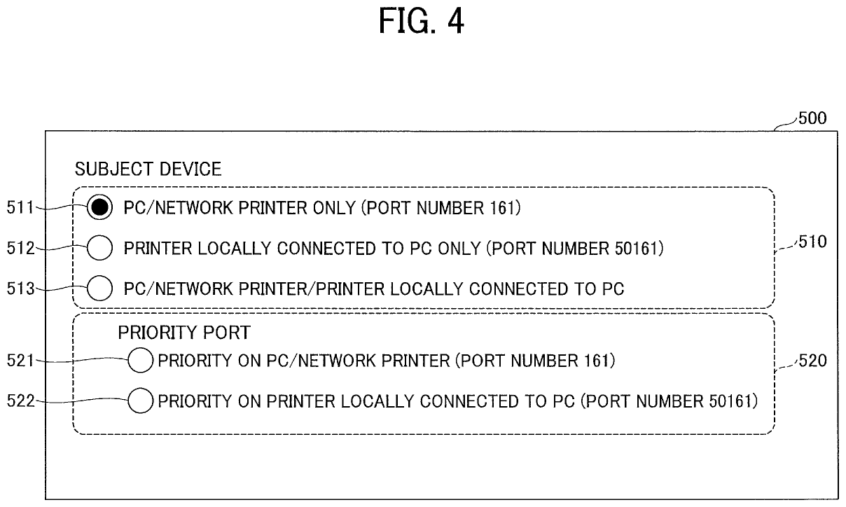

The setting unit 11 receives selection of a port number to be a transmission target (transmission destination) of the device information transmission request, setting of a priority order of port number, and the like. For example, the setting unit 11 displays a setting screen as illustrated in FIG. 4 on a terminal connected to the device management apparatus 10 through a network or a display device connected to the device management apparatus 10.

FIG. 4 is a diagram illustrating an example of a setting screen. In FIG. 4, the setting screen 500 includes a radio button 510, a radio button 520, and the like.

The radio button 510 is a radio button for selecting a device for which device information is to be acquired. The radio button 510 includes options 511 to 513. The option 511 is an option in which only the device information of the client PC 20 and the network printer 30a is acquired. The option 512 is an option in which only the device information of the local printer 30b is to be acquired. The option 513 is an option for which the device information of the client PC 20, the network printer 30a, and the local printer 30b is to be acquired.

The option 511 is also an option corresponding to a request for transmitting device information addressed to port 161. The option 512 is also an option corresponding to a request for transmission of device information addressed to port 50161. Further, the option 513 is also an option corresponding to a request for transmitting device information addressed to both ports (port 161 and port 50161). Therefore, the radio button 510 is also a radio button for selecting a port number of the destination of the transmission request. Port related to port number corresponding to the option selected by the radio button 510 is hereinafter referred to as a “target port”.

The radio button 520 is enabled (operable) when the option 513 is selected by the radio button 510. The radio button 520 is a radio button for selecting which of port 161 and port 50161 is prioritized (which port the device information transmission request is to be preferentially transmitted). The radio button 520 includes options 521 and 522. The option 521 is an option corresponding to giving priority to port 161. The option 522 is an option corresponding to giving priority to port 50161. Hereinafter, a preferred port is referred to as a “priority port”.

The setting unit 11 stores the setting information received through the setting screen 500 in the setting information storage unit 121. The setting information storage unit 121 stores information indicating the target port and the priority port. However, the priority port is included in the setting information when the target port number is both port 161 and port 50161.

The acquisition unit 12 acquires device information by transmitting the device information transmission request based on the setting information stored in the setting information storage unit 121 and receiving a response corresponding to the transmission request. The acquisition unit 12 stores the acquired device information in the device information storage unit 122.

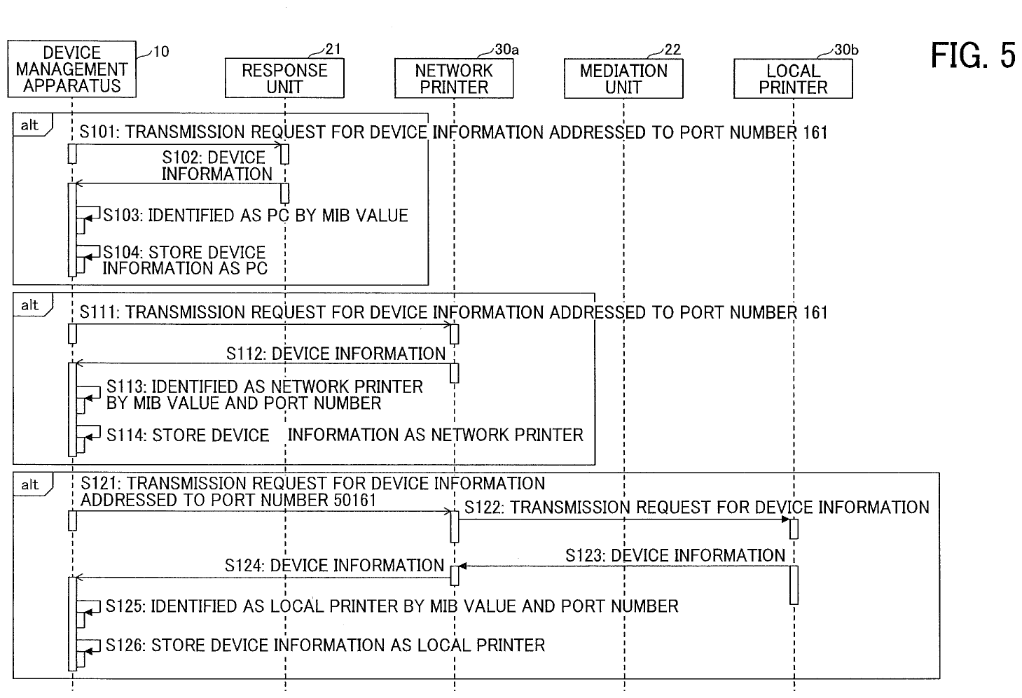

Hereinafter, a description is given of processes performed by the device management system 1. FIG. 5 is a sequence diagram illustrating an example of a process executed when port 161 is the priority port. FIG. 5 describes the process executed when the setting information indicating that the target ports are port 161 and port 50161 and that the priority port is port 161 is stored in the setting information storage unit 121. Specifically, the process is a process executed when option 513 and option 521 are selected on the setting screen 500 illustrated in FIG. 4.

Before executing the process of FIG. 5, it is assumed that a list of internet protocol (IP) address of each device (hereinafter referred to as an “address list”) is set in the device management apparatus 10. The address list may be generated, for example, based on a response to a device search request transmitted by broadcasting from the acquisition unit 12, or may be set by the user.

In step S101, the acquisition unit 12 transmits a transmission request for device information to each IP address included in the address list, in order (series) or in parallel, to port 161 having a relatively high priority, by unicast based on SNMP. An object identifier (ID) corresponding to a device type is designated in the transmission request. The transmission request corresponds to an inquiry for each device type.

When the device corresponding to the IP address of the transmission request is the client PC 20 including the response unit 21, the response unit 21 of the client PC 20 receives the transmission request. In step S102, the response unit 21 transmits a response including, for example, a value indicating “PC” (device type) as a value corresponding to the object ID of the MIB designated in the transmission request (hereinafter referred to as a “MIB value”) as device information to the acquisition unit 12. In step S103, the acquisition unit 12 determines that the device corresponding to the device information included in the response is the client PC 20 based on the MIB value. In step S104, the acquisition unit 12 stores the device information included in the response in the device information storage unit 122 as the device information of the client PC 20. Steps S101, S103, and S104 are repeated for each object ID to be acquired as the client PC 20.

Alternatively, in step S111, when the device corresponding to the IP address of the transmission request is the network printer 30a, the response unit 31a of the network printer 30a receives the transmission request. In step S112, the response unit 31a transmits to the acquisition unit 12, a response including a MIB value indicating “printer” (device type) as a value corresponding to the object ID of the MIB designated in the transmission request as the device information. In step S113, the acquisition unit 12 determines that the device corresponding to the device information included in the response is the network printer 30a based on the MIB value and port number (161) of the destination of the transmission request. In step S114, the acquisition unit 12 stores the device information included in the response in the device information storage unit 122 as the device information of the network printer 30a. Steps S111, S113, and S114 are repeated for each object ID to be acquired as the network printer 30a.

If the device corresponding to the IP address of the transmission request is a device that does not include the response unit 21, the response from the device is not transmitted. This is because port 161 is not opened in the device and the transmission request is discarded.

In step S121, the acquisition unit 12 transmits in order (in series) or in parallel, a request for transmitting device information (inquiry about device type) addressed to port 50161 by unicast based on SNMP to each IP address of each device that does not transmit a response to the device information transmission request addressed to port 161 (the client PC 20 having no response unit).

The transmission request is received by the mediation unit 22 of the client PC 20 corresponding to the device. In step S122, the mediation unit 22 transmits the transmission request to the local printer 30b through the USB cable. In step S123, in response to receiving the transmission request, the response unit 31b of the local printer 30b transmits to the mediation unit 22, a response including, for example, the MIB value indicating “printer” (device type) as the device information corresponding to the object ID of the MIB designated in the transmission request. In step S124, in response to receiving the response, the mediation unit 22 transmits a response including the device information to the acquisition unit 12. In step S125, the acquisition unit 12 determines that the device corresponding to the device information included in the response is the local printer 30b based on the MIB value and port number (50161) of the destination of the transmission request. That is, the mediation unit 22 returns a response to the device information transmission request addressed to port 50161. The transfer is mediated (relayed) by the mediation unit 22 because the device information is from the local printer 30b. As described above, in the present embodiment, it is possible to distinguish whether the collected device information is the device information of the network printer 30a or the local printer 30b.

In step S126, the acquisition unit 12 stores the device information included in the response in the device information storage unit 122 as the device information of the local printer 30b. The steps S121 to S124 and S126 are repeated for each object ID to be acquired as the local printer 30b.

According to FIG. 5, the device information transmission request addressed to port 50161 is transmitted only to the device that does not respond to the device information transmission request addressed to port 161. Therefore, in an environment where the number of client PCs 20 without the local printer 30b connected and network printers 30a is larger than the number of local printers 30b, the device information transmission request can be made by setting port 161 as the target port and as the priority port and the number of transmissions can be reduced.

Further, according to the process illustrated in FIG. 5, when there is a client PC 20 including the response unit 21 and the local printer 30b connected, only the device information of the client PC 20 is stored in the device information storage unit 122 and the device information of the local printer 30b is not stored in the device information storage unit 122. Therefore, if the local printer 30b is to be managed (monitored) rather than the client PC 20, it is preferable not to install the program corresponding to the response unit 21 on the client PC 20.

A process executed when the setting information indicating that the target port is port 161 and port 50161 and that the priority port is port 50161 is stored in the setting information storage unit 121 is described below. The process is executed when option 513 and option 522 are selected on the setting screen 500 illustrated in FIG. 4. Note that the address list is set in advance as in FIG. 5.

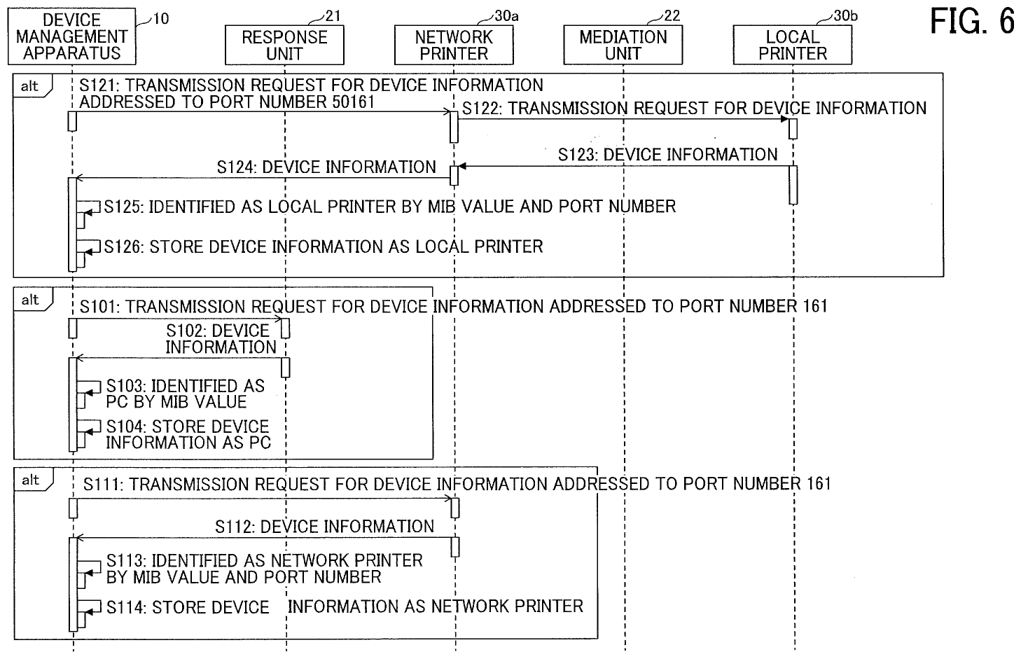

FIG. 6 is a sequence diagram illustrating an example of the process executed when port 50161 is the priority port. In FIG. 6, the same step as in FIG. 5 or the corresponding step is assigned with the same step number, and the description thereof is omitted as appropriate.

The acquisition unit 12 transmits a transmission request for the device information to each IP address included in the address list, in order (series) or in parallel, to port 50161 having a relatively high priority, by unicast based on SNMP. The object ID corresponding to the device type is designated in the transmission request. The transmission request corresponds to an inquiry for each device type.

The transmission request is received by each client PC 20 having the mediation unit 22. Steps S121 to S126 are executed by the mediation unit 22 of each client PC 20, the response unit 31b of each local printer 30b locally connected to each client PC 20, and the acquisition unit 12.

Subsequently, the acquisition unit 12 transmits in order (in series) or in parallel, a transmission request for the device information (inquiry about device type) addressed to port 161 by unicast based on SNMP to each IP address of each device that does not respond to the transmission request for the device information addressed to port 50161 (that is, the client PC 20 that does not have the mediation unit 22 and the network printer 30a).

When the transmission request is received by the client PC 20, steps S101 to S104 are executed.

On the other hand, when the transmission request is received by the network printer 30a, steps S111 to S114 are executed.

According to FIG. 6, the device information transmission request addressed to port 161 is transmitted only to the device that does not respond to the device information transmission request addressed to port 50161. Therefore, in an environment where the 30 number of client PCs 20 and network printers 30a to which the local printer 30b is not connected is larger than the number of local printers 30b, the device information transmission request can be made by setting port 50161 as the target port and as the priority port and the number of transmissions can be reduced.

When only port 161 is the target port (that is, when option 511 is selected on the setting screen 500), only steps S101 to S104 and S111 to S114 are executed.

Further, when only port 50161 is the target port (that is, when option 511 is selected on the setting screen 500), only steps S121 to S126 are executed.

As described above, according to the present embodiment, the device management apparatus 10 can acquire not only the device information of the network printer 30a and the client PC 20 but also the device information of the local printer 30b by transmitting the transmission request for device information having different destination port numbers. Therefore, it is possible to eliminate the need for work such as associating which device is the network printer 30a or the local printer 30b in advance. As a result, the acquisition of information related to the device can be made more efficiently.

Note that the device is not limited to the PC or the printer as long as the device has a communication function. The device includes, for example, an output device such as a multifunction peripheral (MIFP), a projector (PJ), an interactive whiteboard (a whiteboard having an electronic whiteboard function capable of mutual communication (IWB)), a digital signage, a head up display (HUD) device, an industrial machine, an imaging device, a sound collecting device, a medical device, a network home appliance, a mobile phone, a smartphone, a tablet terminal, a game console, a personal digital assistant (PDA), a digital camera, or a wearable PC.

In the present embodiment, port number 161 or port number 50161 is an example of the first port number or the second port number. The client PC 20 is an example of a first device. The local printer 30b is an example of a second device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. A device management apparatus comprising:
circuitry configured to:
transmit a transmission request for acquiring device information to a first port number of each of a plurality of devices connected through a network; and
transmit the transmission request to a second port number of at least one device of the plurality of devices that does not respond to the transmission request transmitted to the first port number.

2. The device management apparatus of claim 1, wherein
one of the transmission request transmitted to the first port number and the transmission request transmitted to the second port number is the transmission request for the device information of a second device connected to the network through a first device, the first device being a transmission destination of the transmission request that is transmitted.

3. The device management apparatus of claim 2, wherein
the circuitry is configured to determine whether information related to a response indicates either the first device or the second device based on to which of the transmission request transmitted to the first port number and the transmission request transmitted to the 20 second port number the response corresponds.

4. A device management system comprising:
a device management apparatus; and
a plurality of devices connected to the device management apparatus through a network, the device management apparatus comprising:
circuitry configured to:
transmit a transmission request for acquiring device information to a first port number of each of the plurality of devices connected through the network; and
transmit the transmission request to a second port number of at least one device of the plurality of devices that does not respond to the transmission request transmitted to the first port number; and
at least one of the plurality of devices comprising:
circuitry configured to:
in response to one of the transmission requests transmitted to the first port number and the transmission request transmitted to the second port number, transfer the transmission request to another device connected to the network through the at least one device; and
transfer to the device management apparatus, device information included in a response to the transmission request from the another device.

5. A device management method comprising:
transmitting a transmission request for acquiring device information to a first port number of each of a plurality of devices connected through a network; and
transmitting the transmission request to a second port number of at least one device of the plurality of devices that does not respond to the transmission request transmitted to the first port number.
